(19) United States
(12) Patent Application Publication
(10) Pub. No.: US 2014/0122515 A1
(43) Pub. Date: May 1, 2014

(54) APPARATUS AND METHOD FOR AIDING DIAGNOSIS

(71) Applicant: SAMSUNG ELECTRONICS CO., LTD., Suwon-si (KR)

(72) Inventors: Ki-Yong Lee, Suwon-si (KR); Yeong-Kyeong Seong, Yongin-si (KR)

(73) Assignee: SAMSUNG ELECTRONICS CO., LTD., Suwon-si (KR)

(21) Appl. No.: 14/058,880

(22) Filed: Oct. 21, 2013

(30) Foreign Application Priority Data
Oct. 30, 2012 (KR) 10-2012-0121551

(51) Int. Cl. G06F 19/00; G06F 17/30

(52) U.S. Cl. CPC G06F 19/322; G06F 17/30477
USPC 707/758

(57) ABSTRACT

An apparatus and method for aiding diagnosis are provided. An apparatus for aiding diagnosis includes: a search unit configured to search a database in which a plurality of data is stored to find a data that matches a medical data of a patient, and a processor configured to display a diagnosis result of the medical data obtained from a computer-aided diagnosis (CAD) system and a search result obtained from the search unit

### CROSS-REFERENCE TO RELATED APPLICATION

This application claims the benefit under 35 U.S.C. §119(a) of a Korean Patent Application No. 10-2012-0121551, filed on Oct. 30, 2012, the entire disclosure of which is incorporated herein by reference for all purposes.

### BACKGROUND

1. Field

The following description relates to a computer-aided diagnosis (CAD) technology and to an apparatus and a method for aiding diagnosis of lesions.

2. Description of Related Art

Computer-aided diagnosis (CAD) systems are diagnosis systems capable of reducing radiologists' workload by highlighting abnormal regions in a medical image based on the results of a quantitative analysis conducted by a computer so as to facilitate radiologists in making their final diagnoses.

In order to reduce the chances of misdiagnosis by a CAD system, it is desirable to periodically update the diagnosis model used by the CAD system and to have the CAD system learn a large amount of medical data. However, in practice, there is a limitation to the amount of learning data that may be provided to train a CAD system.

In addition, even after a user identifies a misdiagnosis of a CAD system and comes up with a final diagnosis of a specific case, the CAD system continues to make the same misdiagnosis in a similar case with similar presentations of medical data. Accordingly, such a CAD system requires a user to identify the misdiagnosis again in the future when similar medical data are presented by another case. Further, the final diagnosis rendered by different radiologists may be different for the same presentation of medical data, further complicating the development of an accurate CAD system.

### SUMMARY

In one general aspect, there is provided an apparatus for aiding diagnosis, including: a search unit configured to search a database in which a plurality of data is stored to find a data that matches a medical data of a patient, and a processor configured to display a diagnosis result of the medical data obtained from a computer-aided diagnosis (CAD) system and a search result obtained from the search unit.

The search unit may be configured to determine a data that includes same information or similar information to the medical data as matching the medical data, and the search result may include a diagnosis from the found data.

The search unit may be configured to find a data as having the same information or the similar information by assigning numerical values to a plurality of lesion features in the medical data, and performing a quantitative analysis by determining whether the data includes one or more of same lesion features as the medical data to satisfy a threshold similarity value.

The general aspect of the apparatus may further include a modifying unit configured to allow a user to modify the diagnosis result from the CAD system.

The processor may be configured to display the diagnosis result from the CAD system together with the search result from the search unit using a predetermined method in response to the search result from the search unit not being the same as the diagnosis result from the CAD system.

The processor may be configured to display the search result with a portion of the found data that differs from the diagnosis result distinguishably from a remaining portion of the found data.

The portion of the found data that differs from the diagnosis result may be displayed with an underline, with a different background color, or in a different color from the remaining portion of the found data.

In response to the search unit finding two or more data among a plurality of data as matching the medical data, the processor may be configured to select a data that is most similar to the diagnosis result from the CAD system and display the selected data with the diagnosis result.

In another general aspect, there is provided a method of aiding diagnosis, involving: receiving a medical data; searching a database in which a plurality of data is stored to find a data that matches the received medical data; and displaying a diagnosis result of the received medical data obtained from a computer-aided diagnosis (CAD) system and a search result from the search unit.

The searching of the database may involve determining a data among the plurality of data that includes same information or similar information to the received medical data as matching the received medical data, and the search result may include a diagnosis from the data that is found to match the received medical data.

The searching of the database may involve determining a data as having the same information or the similar information by assigning numerical values to a plurality of lesion features in the medical data, and performing a quantitative analysis by determining whether the data includes one or more of same lesion features as the medical data to satisfy a threshold similarity value.

The general aspect of the method may further involve: modifying the diagnosis result from the computer-aided diagnosis; and storing the modified diagnosis result in the database.

The displaying of the diagnosis result and the search result may involve displaying the diagnosis result together with the search result using a predetermined method in response to the search result from the search unit not being the same as the diagnosis result from the CAD system.

The displaying of the diagnosis result and the search result may involve displaying the search result with a portion of the found data that differs from the diagnosis result distinguishably from a remaining portion of the found data.

In response to the searching resulting in finding two or more data among the plurality of data as matching the medical data, the displaying of the diagnosis result and the search result may involve selecting a data that is most similar to the diagnosis result and displaying the selected data with the diagnosis result.

In another general aspect, there is provided an apparatus for aiding diagnosis including: a transceiving unit configured to transmit a medical data to a medical data management server, and receive a data that that matches the transmitted medical data from the medical data management server; and a processor configured to display a diagnosis result of the medical data obtained from a computer-aided diagnosis (CAD) system and a search result based on the data received from the medical data management server.

The general aspect of the apparatus may further include a modifying unit configured to allow a user to modify the diagnosis result obtained from the CAD system.

In yet another general aspect, there is provided a method of aiding diagnosis, the method involving: receiving a medical data; transmitting the received medical data to a medical data management server; receiving a data that is the same as or similar to the transmitted medical data from the medical data management server; and displaying a diagnosis result of the received medical data obtained from a computer-aided diagnosis (CAD) system and a search result based on the data received from the medical data management server.

The general aspect of the method may further involve: modifying the diagnosis result obtained from the CAD system; and transmitting the modified diagnosis result to the medical data management server and storing the modified diagnosis result in the medical data management server.

Other features and aspects may be apparent from the following detailed description, the drawings, and the claims.

### BRIEF DESCRIPTION OF THE DRAWINGS

FIG. 1 is a block diagram of an example of an apparatus for aiding diagnosis.

FIG. 2 is a block diagram of an example of a computer-aided diagnosis (CAD) system that includes the apparatus for aiding diagnosis illustrated in FIG. 1.

FIG. 3 is a block diagram of another example of an apparatus for aiding diagnosis.

FIG. 4 is a block diagram of an example of a CAD system that includes the apparatus for aiding diagnosis illustrated in FIG. 3.

FIG. 5A to FIG. 5L are diagrams illustrating examples of methods of displaying diagnosis results and search results in an apparatus for aiding diagnosis.

FIG. 6A to FIG. 6C are diagrams illustrating an example of a method of modifying a diagnosis result of a CAD system.

FIG. 7 is a flowchart illustrating an example of a method of aiding a diagnosis.

FIG. 8 is a flowchart illustrating another example of a method of aiding diagnosis.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Described below are various examples of apparatuses and methods for aiding diagnosis that may prevent a misdiagnosis by a computer-aided diagnosis (CAD) system and may help a user in keeping the diagnosis of similar lesions consistent by: storing medical data of cases in which the diagnoses have been finalized by the user, and searching for and presenting data that is the same as or similar to medical data of a patient.

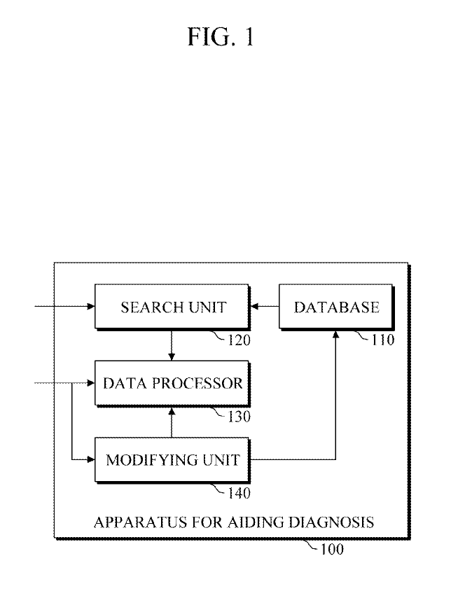

FIG. 1 illustrates an example of an apparatus for aiding diagnosis. Referring to FIG. 1, an apparatus for aiding diagnosis 100 includes a database 110, a search unit 120, and a data processor 130. The apparatus 100 may include data storage or a memory.

In the database 110, a plurality of pieces of medical data may be stored. The database 110 may store the plurality of pieces of medical data in data storage or a memory of the apparatus 100. The pieces of medical data may include medical records of patients, including a diagnostic image of a lesion of the patient and a diagnosis as determined by a radiologist, for example. The database 110 may include a large number of medical records. For example, the database 110 may include more medical records from 10,000 or 100,000 patients. The medical records may further include information regarding the radiologist who made diagnosed the patients, a written description of the image of lesion, such as a size of the lesion, and/or the type of medical imaging device used to diagnose the patients, such as MRI, x-ray, ultrasound, and the like.

The database 110 disposed in the apparatus for aiding diagnosis 100 may be periodically updated by communicating with an external medical database, such as an electronic medical record (EMR) located outside the apparatus 100. The database 110 may be updated with the use of a computer-readable medium provided by a user, such as a flash memory or an optical disk.

The database 110 may be disposed outside the apparatus for aiding diagnosis 100, and in case of necessity, may transmit data to the apparatus 100 for aiding diagnosis.

The database 110 may be an EMR or a database that holds records of an EMR. However, the database 110 is not limited to an EMR, and can be any medical database in which a plurality of pieces of medical data is stored.

The search unit 120 may search the database 110 for a piece of data that has the same or similar presentation of medical data to medical data of a patient, and receive the piece of data from the database 110. For example, the piece of data may correspond to a record of a prior patient whose presentation of medical data is similar to the medical data of the patient to be diagnosed.

As a search method, various methods such as exact search and similarity search can be used.

The search unit 120 may use a lesion feature value extracted from the medical data of the patient to conduct the search. In this case, a similarity may be determined by comparing a difference in lesion feature value between the medical data of the patient and a piece of data in the database 110 with a predetermined threshold. However, the determination may be made in various other ways.

In this example, the lesion feature value can be extracted from the medical data of the patient. The lesion feature value may be features of a lesion such as a shape, margin, and echo pattern of the lesion that is primarily extracted from an image of the lesion. The lesion feature values may be a value that may be obtained through an operation of the features of the lesion primarily extracted from the image of the lesion.

The data processor 130 may graphically render a diagnosis result of a computer-aided diagnosis (CAD) system and the search result received from searching the database 110, by displaying the diagnosis result from the CAD system and the search result of the search unit 120 on a display screen. For example, the diagnosis result from the CAD system and the search result may be displayed on an LCD screen of the apparatus for aiding diagnosis 100.

In an example, the data processor 130 may display the search result to be always shown with the diagnosis result of the CAD system, regardless of whether or not all pieces of information in the data that the search unit 120 found matches the medical data exactly or substantially similarly.

In another example, if the search unit 120 does not find a data that matches the medical data of a current patient exactly or at least similar to the medical data of the patient, or if the search unit 120 found a data that is similar, but the search result is not substantially similar to the diagnosis result of the CAD system, the data processor 130 may display only the diagnosis result of the CAD system. In one example, the similarity between the data found by the search unit 120 and the medical data of the patient may be assessed by quantifying various lesion features of the medical data and determining whether the same or substantially similar lesion feature is present in the data from the database 110. The search result may differ from the diagnosis result of the CAD system in that a diagnosis or various lesion features of the data found in the database 110 may not match the diagnosis or various lesion features as determined by the CAD system.

In another example, when a search is conducted to find data that matches the medical data of a patient to be diagnosed either exactly or substantially similar to the medical data, and the search result did not yield a piece of data that matches the medical data exactly or substantially similarly, the data processor 130 may display the diagnosis result of the CAD system and the search result using a predetermined method. For example, the predetermined method may be a method of displaying the diagnosis result of the CAD system together with a specific mark indicating that data found is not the same as the diagnosis result from the CAD system. In another example, the predetermined method may involve, for example, when the diagnosis result is displayed as a plurality of items, displaying the diagnosis result of the CAD system with items of the found data that differ from the diagnosis result displayed in a distinguishable manner. For example, the items that differ may be highlighted or underlined. In another example, the predetermined method may involve displaying the diagnosis result of the CAD system together with a diagnosis result of data that is most similar to the medical data of the patient among the searched pieces of data, or may involve displaying a distribution chart of diagnosis results of the searched data together with the diagnosis result of the CAD system. However, the display methods are not thereto.

In an additional example, the apparatus for aiding diagnosis 100 may further include a modifying unit 140.

The modifying unit 140 may allow a user to modify the diagnosis result of the CAD system according to a command of the user and confirm a final diagnosis result for the patient whose lesion is being diagnosed. Also, the modifying unit 140 may transfer modified items to the CAD system, so that the CAD system reflects the modified result of the modifying unit 140 and makes a diagnosis again. In other words, the modifying unit 140 can transfer the modified items to the CAD system so that the CAD system makes a diagnosis again, or the modifying unit 140 can confirm a final diagnosis result by only changing the diagnosis result according to the modified items.

Meanwhile, the confirmed final diagnosis result may be stored in the database 110. The confirmed final diagnoses may be used to further train the CAD system.

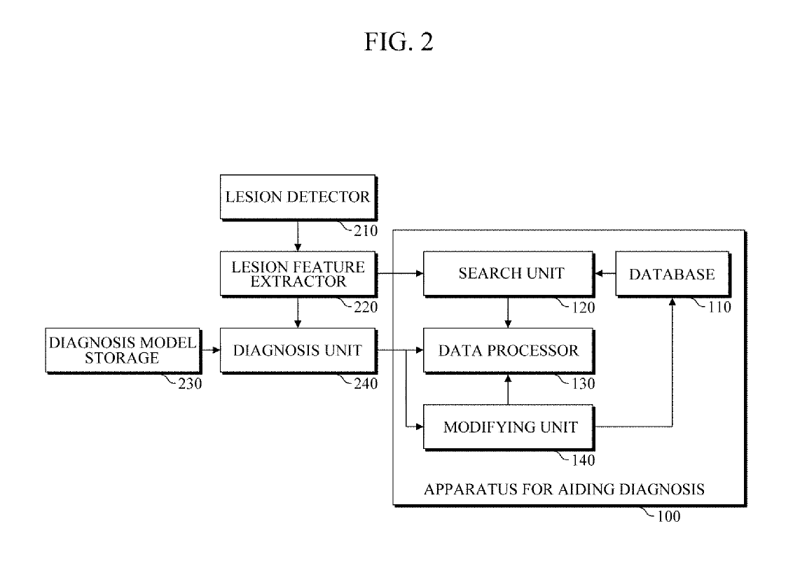

FIG. 2 illustrates an example a CAD system that includes the apparatus 100 of FIG. 1. Referring to FIG. 2, a CAD system may include a lesion detector 210, a lesion feature extractor 220, a diagnosis model storage 230, a diagnosis unit 240, and the apparatus for aiding diagnosis 100.

The lesion detector 210 may detect a position and an approximate size of a lesion from the medical data of the patient. For example, the lesion detector 210 may detect a lesion using various methods such as a method of detecting a lesion by applying an automatic lesion detection algorithm and a method of receiving an input from a user and detecting a lesion.

The medical data of the patient may be, for example, an image or a numerical data obtained from a single or a plurality of radiographic imaging apparatuses, an ultrasonographic apparatus, a magnetic resonance imaging (MRI) apparatus, a computed tomography (CT) apparatus, and so on.

The lesion feature extractor 220 may extract a feature value of a lesion from a lesion area searched by the lesion detector 210. For example, the lesion feature value may be features such as a shape, margin, and echo pattern of the lesion first extracted from the searched lesion area, or a value that may be obtained through performing an operation or analysis of the feature first extracted from the image of the lesion.

The diagnosis model storage 230 may store a diagnosis model used to diagnose a lesion.

The diagnosis unit 240 may make a diagnosis of a lesion using the lesion feature values extracted by the lesion feature extractor 220 and the diagnosis model stored in the diagnosis model storage 230.

The apparatus for aiding diagnosis 100 may include the database 110, the search unit 120, the data processor 130, and the modifying unit 140. In this example, the detailed constitution of the apparatus 100 is the same as that of the example illustrated in FIG. 1 except for the features described below, and the detailed description thereof will be omitted.

The search unit 120 may receive the extracted lesion feature value from the lesion feature extractor 220 and search the database 110 for data that matches the medical data of a patient to be diagnosed. The search unit 120 may search for a piece of data that has the same or similar presentation of lesions as the medical data of the patient to be diagnosed. The data processor 130 may display the diagnosis result received from the diagnosis unit 240 and the data search result of the search unit 120 according to the data search result of the search unit 120.

The modifying unit 140 may modify the diagnosis result received from the diagnosis unit 240 according to a command of a user and confirm a final diagnosis result. Also, the modifying unit 140 may transfer modified items to the lesion detector 210, the lesion feature extractor 220, or the diagnosis unit 240 in order to reflect the modified items and make a diagnosis again.

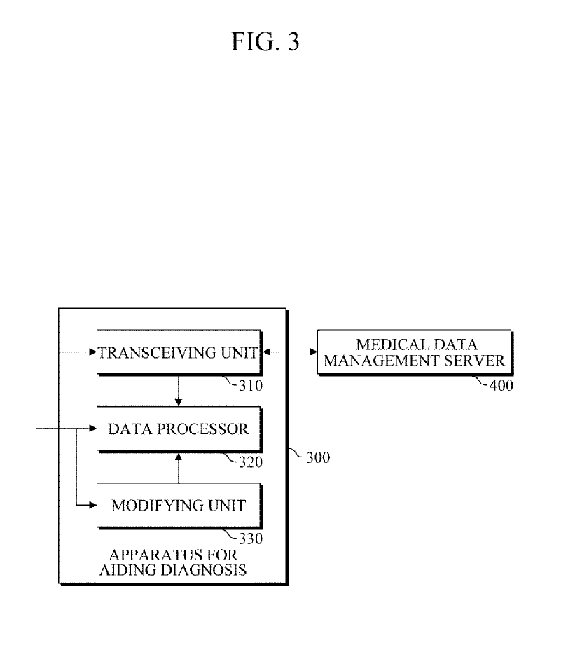

FIG. 3 illustrates another example of an apparatus for aiding diagnosis.

As shown in FIG. 3, an apparatus for aiding diagnosis 300 may include a transceiving unit 310 and a data processor 320. The transceiving unit 310 may receive data from or transmit data to a medical data management server 400.

In this example, the medical data management server 400 is a server that stores and manages a plurality of pieces of medical data, and may receive medical data of a patient from the apparatus for aiding diagnosis 300. The medical data management server 400 may also conduct a search for data that is the same as or similar to the received medical data of the patient, and transmit the data that has been found to the lesion-diagnosis aid apparatus 300.

The transceiving unit 310 may transmit the medical data of the patient to the medical data management server 400 and may receive the search result of the data that is the same as or similar to the medical data of the patient from the medical data management server 400.

The data processor 320 may display a diagnosis result of a CAD system and the search result received from the medical data management server 400 according to the data search result of the medical data management server 400.

In an example, the data processor 320 may display the search result received from the medical data management server 400 to be always displayed together with the diagnosis result of the CAD system, regardless of whether or not the search successfully resulted in finding a data that is the same as or similar to the medical data of the patient.

In another example, in the event that the search did not result in finding a data that is the same as or similar to the medical data of the patient, or is searched but the search result is the same as or similar to the diagnosis result of the CAD system, the data processor 320 may display only the diagnosis result of the CAD system.

In still another example, when a search for data that is the same as or similar to the medical data of the patient is conducted but the search result is not substantially similar to the diagnosis result of the CAD system, as determined by a threshold of similarity, the data processor 320 may display the diagnosis result of the CAD system and the received search result using a predetermined method. Examples of the predetermined methods that may be used include: (1) a method of displaying the diagnosis result of the CAD system together with a specific mark; (2) a method of, when the diagnosis result is displayed as a plurality of items, displaying the diagnosis result of the CAD system with only items that are different from the search result among the plurality of items displayed in a distinguishable manner; (3) a method of displaying the diagnosis result of the CAD system together with a diagnosis result of data that is most similar to the medical data of the patient among the searched pieces data; (4) a method of displaying a distribution chart of diagnosis results of the searched data together with the diagnosis result of the CAD system; and the like. However, the methods of displaying the results are not limited to these examples.

In an additional example, the apparatus for aiding diagnosis 300 may further include a modifying unit 330.

The modifying unit 330 may modify the diagnosis result of the CAD system according to a command of a user and confirm a final diagnosis result. For example, the modifying unit 330 may allow the user to change the diagnosis result. Also, the modifying unit 330 may transfer modified items to the CAD system, so that the CAD system reflects the modified result of the modifying unit 330 and makes a diagnosis again. In other words, the modifying unit 330 can transfer the modified items to the CAD system so that the CAD system makes a lesion diagnosis for a second time. In the alternative, the modifying unit 330 can confirm a final diagnosis result by only changing the diagnosis result according to the modified items.

Meanwhile, the transceiving unit 310 may transmit the confirmed final diagnosis result to the medical data management server 400 so that the medical data management server 400 can store the confirmed final diagnosis result.

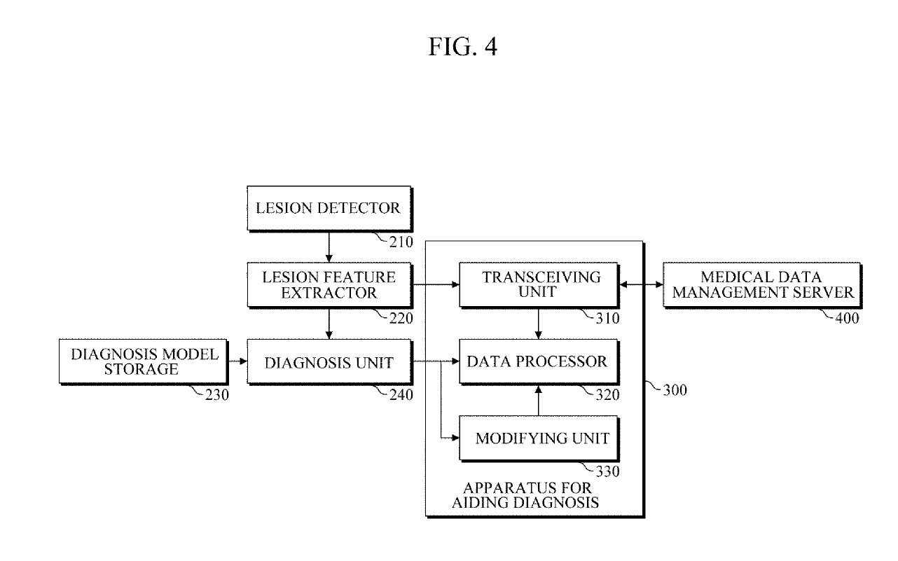

FIG. 4 illustrates another example of a CAD system. The CAD system illustrated in FIG. 4 includes the apparatus for aiding diagnosis 300 of FIG. 3. As shown in FIG. 4, a CAD system may include a lesion detector 210, a lesion feature extractor 220, a diagnosis model storage 230, a diagnosis unit 240, an apparatus for aiding diagnosis 300, and a medical data management server 400. In this example, the lesion detector 210, the lesion feature extractor 220, the diagnosis model storage 230, and the diagnosis unit 240 perform the same functions as the respective components shown in FIG. 2, and the detailed description thereof will be omitted.

Also, the detailed constitution of the apparatus 300 and the medical data management server 400 are the same as those illustrated in FIG. 3 except for functions described below, and the detailed description thereof will be omitted.

The transceiving unit 310 may receive an extracted lesion feature value from the lesion feature extractor 220 and transmit the lesion feature value to the medical data management server 400. The data processor 320 may display a diagnosis result received from the diagnosis unit 240 and a data search result received from the medical data management server 400 according to the data search result of the medical data management server 400.

The modifying unit 330 may modify the diagnosis result received from the diagnosis unit 240 according to a command of a user and confirm a final diagnosis result. Also, the modifying unit 330 may transfer modified items to the lesion detector 210, the lesion feature extractor 220, or the diagnosis unit 240, so that a diagnosis can be made again by reflecting the modified items.

Meanwhile, the medical data management server 400 may be included in the CAD system or be located outside the CAD system.

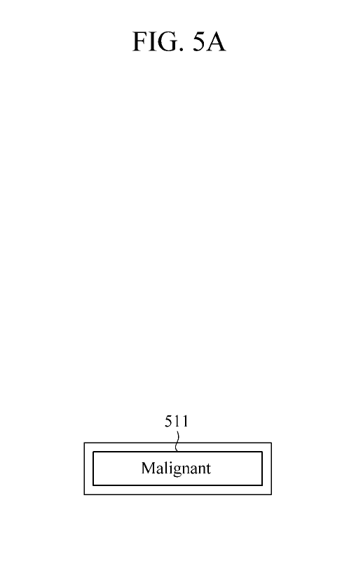

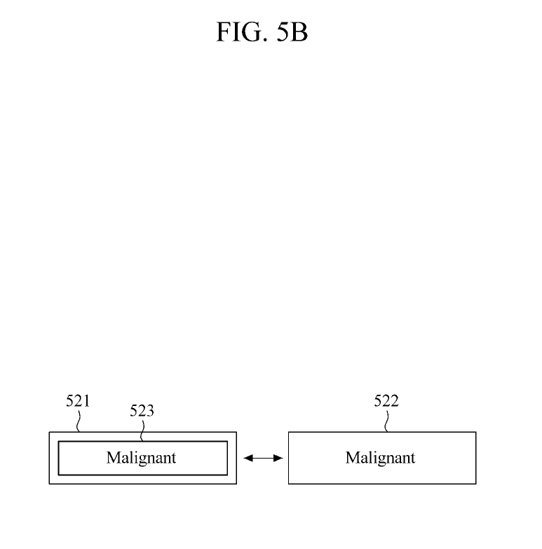

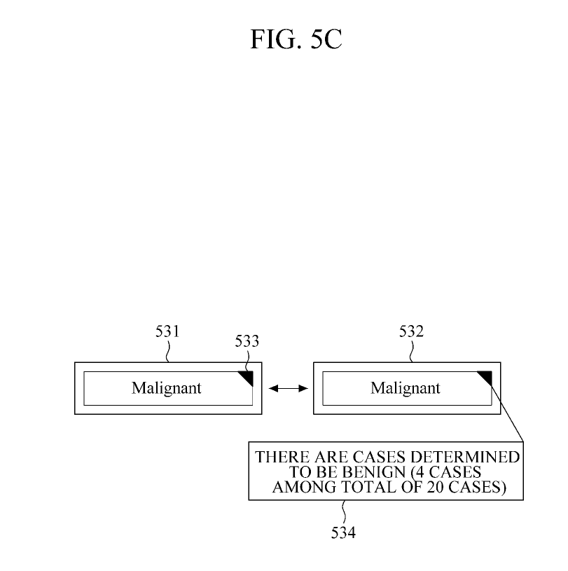

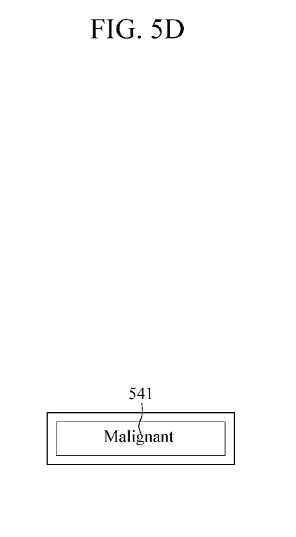

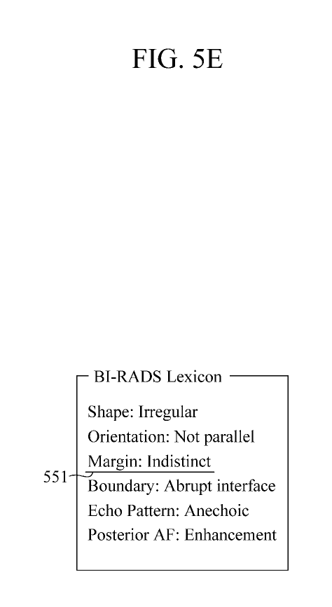

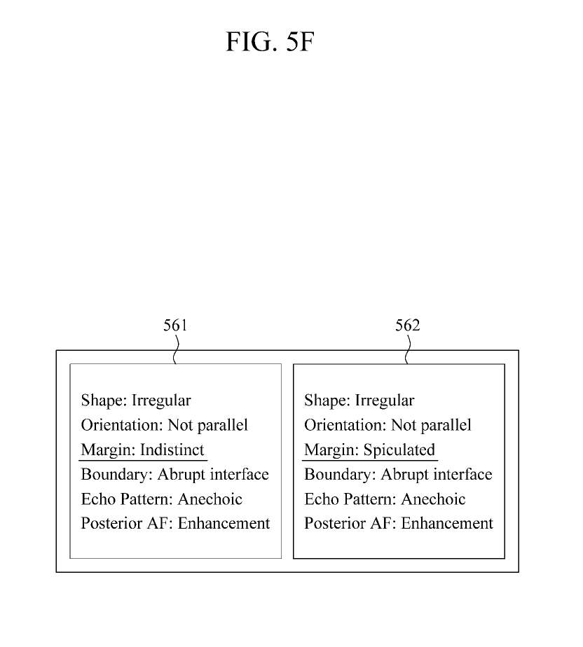

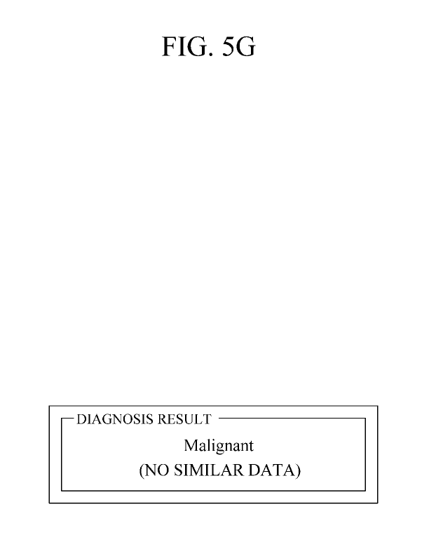

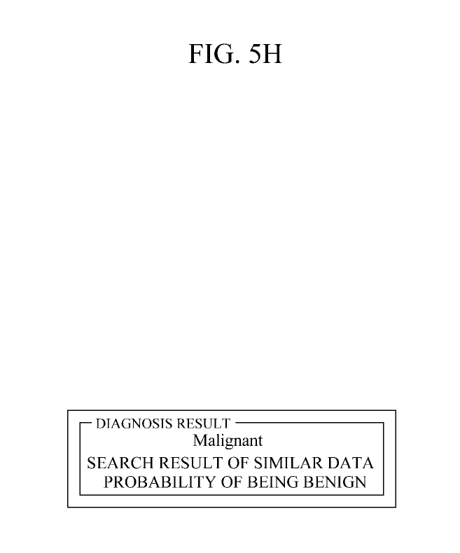

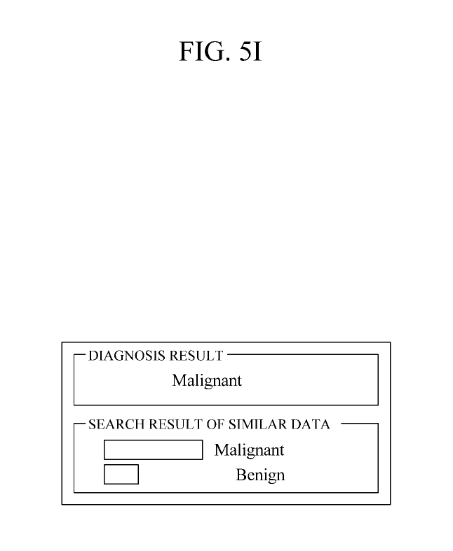

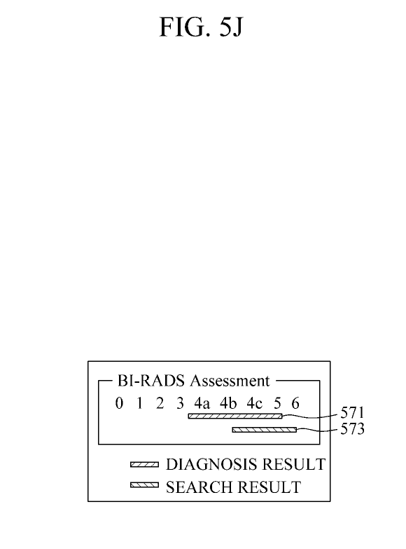

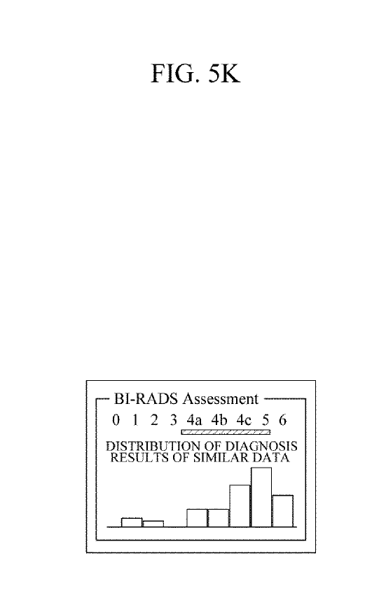

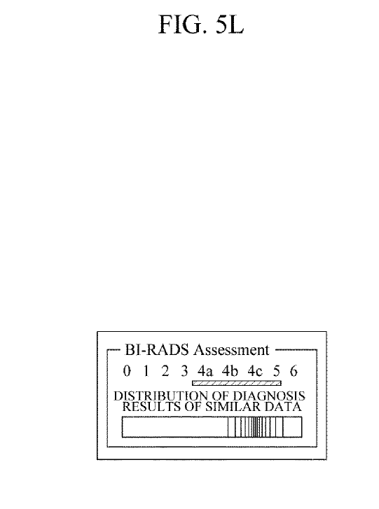

FIG. 5A to FIG. 5L are diagrams illustrating examples of methods of displaying a diagnosis result of a CAD system and a search result from database search.

Referring to FIG. 5A, in this example, a search was conducted for a data that is the same as or similar to the medical data of a patient, and the diagnosis of the found data is not the same as a diagnosis found in the diagnosis result of the CAD system.

In FIG. 5A, when a diagnosis result of a CAD system is shown, a rectangular FIG. 511 surrounding a diagnosis result may be displayed to indicate that there is a difference between the diagnosis result of the CAD system and a diagnosis of the data found during the database search.

Although a rectangular FIG. 511 is used to display the difference in this example, a figure other than a rectangle can also be displayed, or various combinations of colors and figures may be used in other examples. In addition, the rectangular FIG. 511 can be displayed in a specific color. Any method capable of notifying a user, such as a doctor or a radiologist, that there is a difference between a diagnosis result of a CAD system and a search result from the database can used.

Referring to FIG. 5B, when a diagnosis result of a CAD system is displayed, a blinking effect, and the like, can be used to indicate that there is a difference between the diagnosis result of the CAD system and the search result. In other words, as shown in a left screen 521 of the drawing, a diagnosis result of a CAD system may be shown in a rectangular FIG. 523. After a predetermined time elapses, the rectangular FIG. 523 disappears as shown in a right screen 522 of the drawing. When a predetermined time elapses thereafter, as shown in the left screen 521 of the drawing, the rectangular FIG. 523 may be displayed again. In other words, using the blinking effect achieved by repeating the disappearance and the appearance of the rectangular FIG. 523, it is possible to display that there is a difference between a diagnosis result of a CAD system and a search result.

Referring to FIG. 5C, when a diagnosis result of a CAD system is shown, a specific mark may be inserted. As shown in a left screen 531 of the drawing, a specific mark 533 is displayed together with a diagnosis result. When a user moves a cursor onto the specific mark 533 or clicks on the specific mark 533, an interface 534 providing detailed description of a search result may be displayed as shown in a right screen 532 of the drawing. Here, the specific mark includes various marks recognizable by a user such as an icon and a figure.

Referring to FIG. 5D, when a diagnosis result of a CAD system is shown, the diagnosis result may be displayed in bold letters 541. Also, it is possible to show a diagnosis result using various letter effects that can be distinguished by a user such as an effect of showing the diagnosis result in a specific color or a specific font.

Referring to FIG. 5E, when a diagnosis result consists of a plurality of items and is shown according to the plurality of items, the diagnosis result of a CAD system may be shown with only items different from a search result among the plurality of items distinguishably displayed. FIG. 5E illustrates a case in which an item of a diagnosis result of a CAD system that is different from the search result is displayed with an underline 551.

Referring to FIG. 5F, a diagnosis result 561 of a CAD system and a diagnosis result 562 of searched data are displayed together. In this example, if the diagnosis results 561 and 562 consist of a plurality of items, the diagnosis result 561 of a CAD system and the diagnosis result 562 of searched data may be shown together, with only items different from each other among the plurality of items displayed in a distinguishable manner. For example, the item can be underlined, highlighted, displayed in different color, displayed with different font, and the like. Even if there is no difference between the two results, when the same or similar data is searched, it is possible to always display the diagnosis result of searched data together with the diagnosis result of a CAD system.

Referring to FIG. 5G to FIG. 51, when a diagnosis result of a CAD system is displayed, a search result of the same or similar data may be displayed together or an indication may be given that a data that matches the medical data of the patient has not been found during the search.

Referring to FIG. 5G, for example, a diagnosis result is displayed with an indication that no data that is similar to or the same as the medical data of the patient to be diagnosed was not found during the search. Referring to FIG. 5H, a diagnosis result is displayed together with a probability that the diagnosis is correct or incorrect, based on a calculation based on pieces of data having diagnosis results that are not the same as the diagnosis results of a CAD system among the pieces of similar data found during the search. Referring to FIG. 51, a diagnosis result from a CAD system is displayed together with a search result of the data found during the database search. The search result includes a bar showing the likelihood so that a diagnosis found in the diagnosis result by the CAD system may be correct or incorrect, based on the diagnoses of a plurality of data found to have presented similar lesion features in the database.

Referring to FIG. 5J, when a diagnosis result of a CAD system is displayed, a diagnosis result of data that is most similar to the medical data of a patient may be displayed. For example, a diagnosis result 571 of a CAD system and a diagnosis result 573 of data that is most similar to medical data of a patient among searched data may be displayed together.

Referring to FIG. 5K and FIG. 51, when a diagnosis result of a CAD system is displayed, a distribution chart of diagnoses of a plurality of data found to include the same or similar information with the medical data of the patient may be displayed together. FIG. 5K is an example in which a distribution chart of diagnoses of the data found to include the same or similar information as the medical data of the patient is displayed in the form of a histogram. In FIG. 5L, the distribution of diagnosis results of similar data is displayed in the form of a gradient bar. A distribution of diagnosis results of the searched data may be shown in various other forms, using graphs, colors, density and other visual or audio effects.

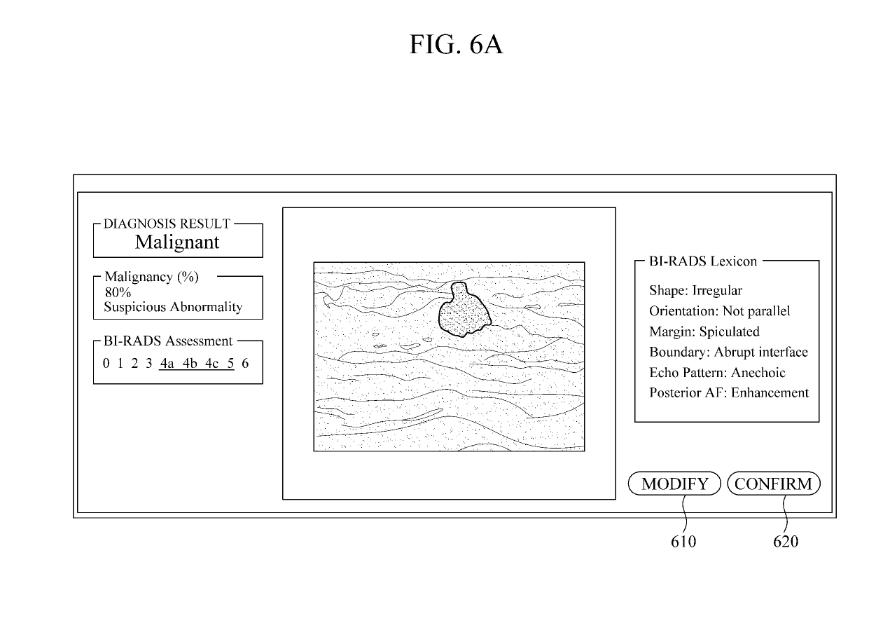

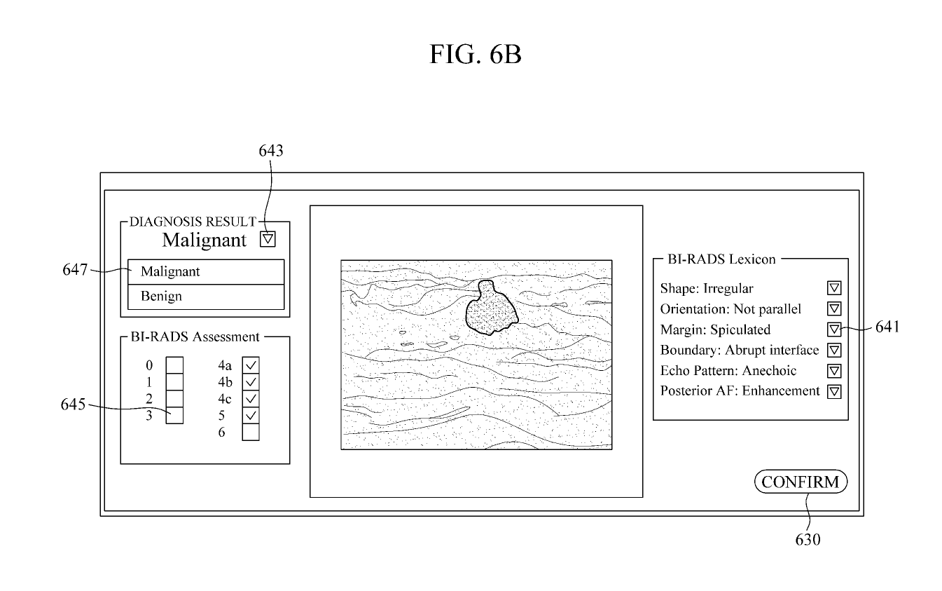

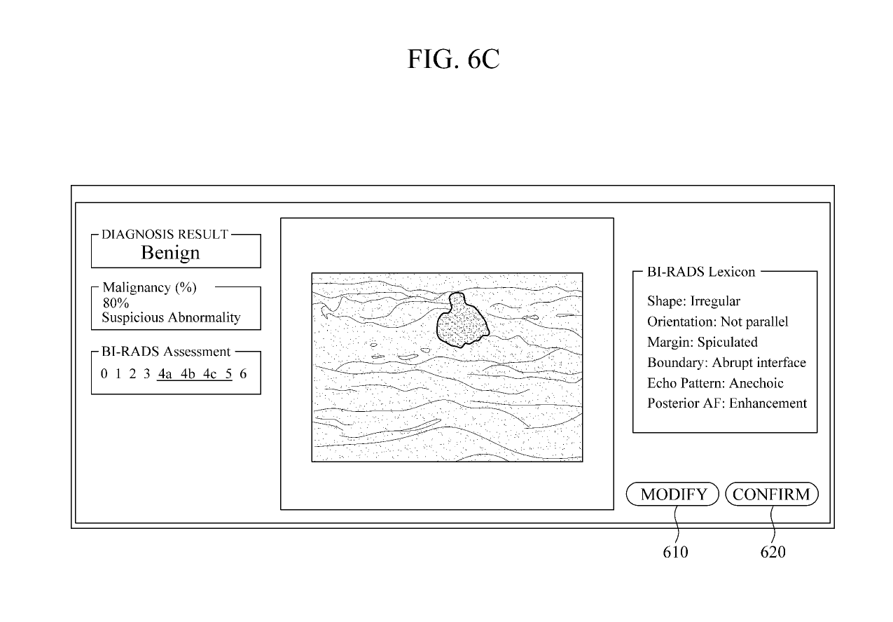

FIG. 6A to FIG. 6C are diagrams illustrating examples of methods of modifying a diagnosis result of a CAD system obtained according to examples of FIG. 1 or FIG. 3. For example, FIG. 6A illustrates an example of a screen that displays a diagnosis result of a CAD system. FIG. 6B illustrates an example of a screen that displays a user interface through which a diagnosis result can be modified. FIG. 6C illustrates an example of a screen that displays a diagnosis result modified by a user.

While FIGS. 6A-6C illustrate a display screen in which only the diagnosis result is displayed, in other examples, when data that is the same as or similar to medical data of a patient is searched, the data search result is displayed together with the diagnosis result from the CAD system. However, for convenience of description, in FIGS. 6A-6C, the display of the data search result is omitted. Also, for convenience of description, it is assumed that a user only modifies an item that is diagnosed as malignant or benign in a diagnosis result consisting of a plurality of items.

Referring to FIG. 6A, when a diagnosis result of a CAD system is displayed, a modification button 610 for enabling a user to modify the diagnosis result and a confirm button 620 for settling the diagnosis result as a final diagnosis result are displayed together. When the user clicks the modification button 610, as shown in FIG. 6B, buttons 641, 643, and 645 for enabling the user to modify respective items of the diagnosis result are displayed.

Referring to FIG. 6B, when the user clicks the button 643 to modify a diagnosis result determined to be “Malignant” by a CAD system, a popup dialog box 647 in which “Malignant” or “Benign” can be selected is displayed. The user can modify the diagnosis result as “Benign” by clicking on “Benign” in the popup dialog box 647. After that, when a confirm button 630 is clicked, the modification is finished, and the modified diagnosis result is displayed as shown in FIG. 6C.

Referring to FIG. 6C, when the user wants to modify the diagnosis result again, it is possible to re-modify the diagnosis result by clicking the modification button 610 again. On the other hand, when no more modification is necessary, it is possible to confirm a final diagnosis result and finish the diagnosis by clicking the confirm button 620. Thus, in this example, it is possible to confirm the final diagnosis result and finish the diagnosis by clicking the confirm button 620, or the CAD system can reflect modified items and make a diagnosis again.

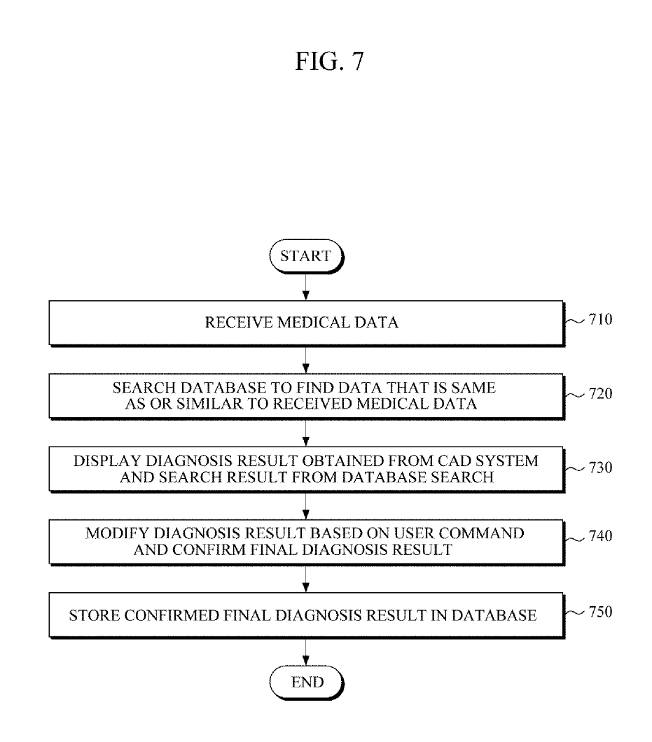

FIG. 7 is a flowchart illustrating an example of a method of aiding diagnosis of a lesion.

Referring to FIG. 7, in a lesion-diagnosis aiding method, a medical data of a patient to be diagnosed is received in 710, and a database search is conducted to find a data that includes the same information or similar information as the received medical data of the patient among a plurality of pieces of medical data stored in a database in 720.

As a search method, various methods such as exact search and similarity search can be used.

For example, a lesion feature value extracted from the medical data of the patient may be used to determine whether a piece of medical data stored in the database matches the medical data of the patient to be diagnosed. In this case, a similarity may be determined by comparing a difference in lesion feature value between the medical data of the patient and a piece of data in the database with a predetermined threshold. The medical data of the patient may include a plurality of lesion features, and the lesion feature values for each feature may be compared in the piece of data in the database. However, the determination may be made with various different methods, and the determination method is not limited thereto.

The lesion feature value can be extracted from the medical data of the patient, and may be features of a lesion directly extracted from a medical image such as a shape, margin, and echo pattern of the lesion in the image, or a value that may be obtained secondarily through performing an operation on the features of the lesion extracted primarily by visual analysis. In an example, values may be assigned to the extracted features by assigning numerical values to shape, margin and echo pattern extracted from the medical image.

Subsequently, a result of a diagnosis of the medical data of the patient made by a CAD system and the data search result are displayed according to the data search result in 730.

In an example, the search result may be visualized to be always shown with the diagnosis result of the CAD system, regardless of whether or not data that is the same as or similar to the medical data of the patient is searched.

In another example, when a search is conducted to find a data that includes the same information or similar information as the medical data of the patient, and such data is not found or the search result does not match the diagnosis result of the CAD system, only the diagnosis result of the CAD system may be displayed.

In still another example, when a database search is conducted to find data that includes the same information or similar information as the medical data of the patient and a diagnosis result of the data does not match the diagnosis result of the CAD system, the diagnosis result of the CAD system and the search result may be displayed using a predetermined method to indicate the difference between the diagnosis result and the search result. For example, the diagnosis result of the CAD system may be displayed together with a specific mark indicating that data having a different diagnosis result from the diagnosis result of the CAD system has been found. In another example, when the diagnosis results are displayed as a plurality of items, the diagnosis result of the CAD system is shown with only items different from the diagnosis result of the searched data among the plurality of items distinguishably displayed. In another example, the diagnosis result of the CAD system is displayed together with a diagnosis result of data that is most similar to the medical data of the patient among the searched pieces of data. In yet another example, a distribution chart of diagnosis results of the searched data is displayed together with the diagnosis result of the CAD system. However, the aforementioned display methods are merely examples, and the predetermined method is not limited to these. It is possible to display the search result using various methods.

After that, a final diagnosis result is confirmed by modifying the diagnosis result of the CAD system according to a user command in 740.

Subsequently, the confirmed final diagnosis result is stored in the database in 750.

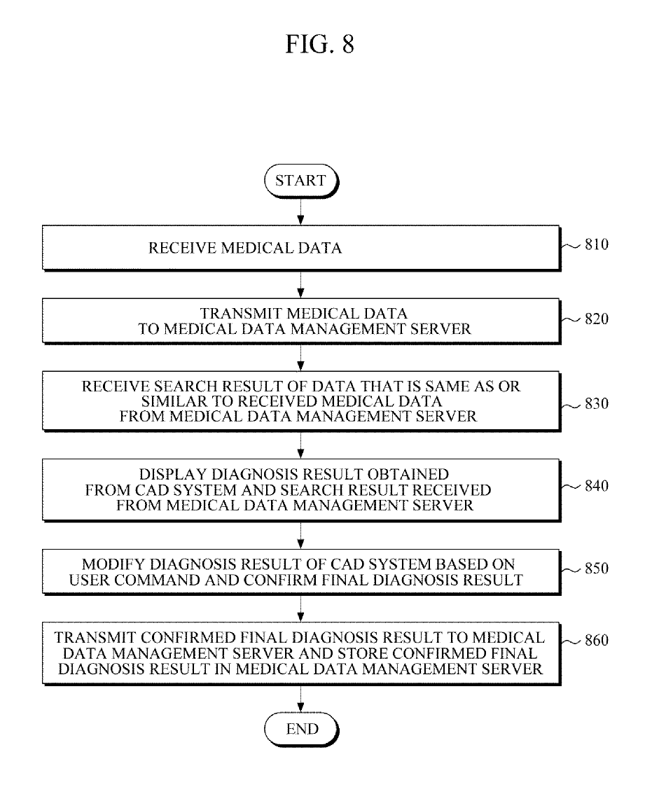

FIG. 8 is a flowchart illustrating an example of a method of aiding diagnosis.

Referring to FIG. 8, in a method of aiding diagnosis, a medical data of a patient is received in 810, and the medical data of the patient is transmitted to a medical data management server 400 in which a plurality of pieces of medical data are stored in 820. In this example, the medical data management server 400 is a server that stores and manages the plurality of pieces of medical data. The medical data management server 400 may receive the medical data of the patient from an apparatus for aiding diagnosis, and may search for data that is the same as or similar to the medical data of the patient.

After that, the search result of data that is the same as or similar to the medical data of the patient is received from the medical data management server 400 in 830.

Subsequently, a diagnosis result of the medical data of the patient obtained from a CAD system and the received search result are processed to be displayed according to the received search result in 840.

In an example, the received search result may be processed to be always shown with the diagnosis result of the CAD system, regardless of whether or not data that is the same as or similar to the medical data of the patient is found in the medical data management server 400.

In another example, when data that is the same as or similar to the medical data of the patient is not found, or is searched but the search result is the same as or similar to the diagnosis result of the CAD system, a data processor 320 may display only the diagnosis result of the CAD system.

In still another example, when data that is the same as or similar to the medical data of the patient is searched and the search result is not the same as or similar to the diagnosis result of the CAD system, the data processor 320 may display the diagnosis result of the CAD system and the received search result using a predetermined method. In this example, the predetermined method may be, for example, a method of displaying the diagnosis result of the CAD system together with a specific mark; a method of, when the diagnosis result is displayed as a plurality of items, displaying the diagnosis result of the CAD system with only items different from the search result among the plurality of items distinguishably displayed; a method of showing the diagnosis result of the CAD system together with a diagnosis result of data that is most similar to the medical data of the patient among the searched pieces data; or a method of showing a distribution chart of diagnosis results of the searched data together with the diagnosis result of the CAD system. However, the method of displaying the diagnosis result is not limited thereto.

After that, a final diagnosis result is confirmed by modifying the diagnosis result of the CAD system according to a command of a user in 850.

Subsequently, the confirmed final diagnosis result is transmitted to and stored in the medical data management server in 860.

In another example, medical data of a patient for which a diagnosis has been finished is stored, and data that is the same as or similar to medical data of a patient is searched for and presented, so that a misdiagnosis of a CAD system for a similar data can be prevented in the future.

In addition, it is possible to assist a user to keep the consistency of lesion diagnoses of similar medical data.

Various examples of apparatuses and methods for aiding diagnosis are described above. In one example, an apparatus for aiding lesion diagnosis includes: a search unit configured to search a database in which a plurality of pieces of medical data are stored for data that is the same as or similar to medical data of a patient; and a data processor configured to visualize a result of a diagnosis of the medical data of the patient made by a CAD system and the data searched from the database. In another example, an apparatus for aiding lesion diagnosis includes: a transceiving unit configured to transmit medical data of a patient to a medical data management server in which a plurality of pieces of medical data are stored, and receive data that is the same as or similar to the medical data of the patient from the medical data management server; and a data processor configured to visualize a result of a diagnosis of the medical data of the patient made by a CAD system and the data received from the medical data management server. In another example, a method of aiding lesion diagnosis includes: receiving medical data of a patient; searching a database in which a plurality of pieces of medical data are stored for data that is the same as or similar to the received medical data of the patient; and visualizing a result of a diagnosis of the medical data of the patient made by a CAD system and the data searched from the database. In another example, a method of aiding lesion diagnosis includes: receiving medical data of a patient; transmitting the received medical data of the patient to a medical data management server in which a plurality of pieces of medical data are stored; receiving data that is the same as or similar to the medical data of the patient from the medical data management server; and visualizing a result of a diagnosis of the medical data of the patient made by a CAD system and the data received from the medical data management server.

Various examples of methods and units described above may be implemented, in part, with computer readable codes. The computer readable codes may be stored in a non-transitory computer-readable recording medium. The computer-readable recording medium includes all types of record media in which computer readable data may be stored. Examples of non-transitory computer-readable recording medium include a ROM, a RAM, a CD-ROM, a magnetic tape, a floppy disk, flash memory, and an optical data storage. Further, the recording medium may be implemented in the form of a carrier wave such as Internet transmission. In addition, the computer-readable recording medium may be distributed to computer systems over a network, in which computer readable codes may be stored and executed in a distributed manner.

Various units as described above may be implemented using hardware components and software components. For example, the units may include a processing device, a display unit, a touch screen, a microprocessor, a memory, a data storage unit, radio signal transmitter, internet server, and the like. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller, and a processor may be shared between two or more units.

The software may include a computer program, a piece of code, an instruction, or some combination thereof, for independently or collectively instructing or configuring the processing device to operate as desired. Programs, codes, and code segments for accomplishing the examples disclosed herein can be easily construed by programmers skilled in the art to which the examples pertain based on and using the flow diagrams and block diagrams of the figures and their corresponding descriptions as provided above.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for aiding diagnosis, comprising:
a search unit configured to search a database in which a plurality of data is stored to find a data that matches a medical data of a patient; and
a processor configured to display a diagnosis result of the medical data obtained from a computer-aided diagnosis (CAD) system and a search result obtained from the search unit.

2. The apparatus of claim 1, wherein the search unit is configured to determine a data that includes same information or similar information to the medical data as matching the medical data; and the search result includes a diagnosis from the found data.

3. The apparatus of claim 2, wherein the search unit is configured to find a data as having the same information or the similar information by assigning numerical values to a plurality of lesion features in the medical data, and performing a quantitative analysis by determining whether the data includes one or more of same lesion features as the medical data to satisfy a threshold similarity value.

4. The apparatus of claim 1, further comprising a modifying unit configured to allow a user to modify the diagnosis result from the CAD system.

5. The apparatus of claim 1, wherein the processor is configured to display the diagnosis result from the CAD system together with the search result from the search unit using a predetermined method in response to the search result from the search unit not being the same as the diagnosis result from the CAD system.

6. The apparatus of claim 5, wherein the processor is configured to display the search result with a portion of the found data that differs from the diagnosis result distinguishably from a remaining portion of the found data.

7. The apparatus of claim 6, wherein the portion of the found data that differs from the diagnosis result is displayed with an underline, with a different background color, or in a different color from the remaining portion of the found data.

8. The apparatus of claim 5, wherein, in response to the search unit finding two or more data among a plurality of data as matching the medical data, the processor is configured to select a data that is most similar to the diagnosis result from the CAD system and display the selected data with the diagnosis result.

9. A method of aiding diagnosis, comprising:
receiving a medical data;
searching a database in which a plurality of data is stored to find a data that matches the received medical data; and
displaying a diagnosis result of the received medical data obtained from a computer-aided diagnosis (CAD) system and a search result from the search unit.

10. The method of claim 9, wherein the searching of the database comprises determining a data among the plurality of data that includes same information or similar information to the received medical data as matching the received medical data; and the search result includes a diagnosis from the data that is found to match the received medical data.

11. The method of claim 10, wherein the searching of the database comprises determining a data as having the same information or the similar information by assigning numerical values to a plurality of lesion features in the medical data, and performing a quantitative analysis by determining whether the data includes one or more of same lesion features as the medical data to satisfy a threshold similarity value.

12. The method of claim 9, further comprising:
modifying the diagnosis result from the computer-aided diagnosis; and
storing the modified diagnosis result in the database.

13. The method of claim 9, wherein the displaying of the diagnosis result and the search result comprises displaying the diagnosis result together with the search result using a predetermined method in response to the search result from the search unit not being the same as the diagnosis result from the CAD system.

14. The method of claim 13, wherein the displaying of the diagnosis result and the search result comprises displaying the search result with a portion of the found data that differs from the diagnosis result distinguishably from a remaining portion of the found data.

15. The method of claim 13, wherein, in response to the searching resulting in finding two or more data among the plurality of data as matching the medical data, the displaying of the diagnosis result and the search result comprises selecting a data that is most similar to the diagnosis result and displaying the selected data with the diagnosis result.

16. An apparatus for aiding diagnosis, comprising:
a transceiving unit configured to transmit a medical data to a medical data management server, and receive a data that that matches the transmitted medical data from the medical data management server; and
a processor configured to display a diagnosis result of the medical data obtained from a computer-aided diagnosis (CAD) system and a search result based on the data received from the medical data management server.

17. The apparatus of claim 16, further comprising a modifying unit configured to allow a user to modify the diagnosis result obtained from the CAD system.
